(19) United States
(12) Patent Application Publication
(10) Pub. No.: US 2010/0225218 A1
(43) Pub. Date: Sep. 9, 2010

(54) Lighting Device

(75) Inventors: Richard Landry Gray, Saratoga, CA (US); Po Ming Tsai, Taipei (TW)

Correspondence Address: Richard Landry Gray, 18900 Aspesi Drive, Saratoga, CA, 95070, US

(73) Assignee: Richard Landry Gray, Saratoga, CA (US)

(21) Appl. No.: 12/493,177

(22) Filed: Jun. 27, 2009

Related U.S. Application Data
(60) Provisional application No. 61/158,462, filed on Mar. 9, 2009.

(51) Int. Cl. H01J 61/52; H01J 5/48

(52) U.S. Cl. 313/46; 313/318.01

(57) ABSTRACT

The lighting device in accordance with the present invention comprises a base, at least one ruminant and an electronic module. The base is a lamp connector and comprises a contact and an insulated cap. The at least one luminant is mounted on the base. The electronic module drives the at least one luminant, is mounted on the base and is connected electrically to the base.

### FIELD OF THE INVENTION

The present invention is a lighting device.

### BACKGROUND OF THE INVENTION

Lighting technology continues to progress in several areas including higher efficiency, longer life, lower environmental impact and lower cost. At the present time, hot cathode fluorescent lamps (HCFL) and compact fluorescent lamps (CFL) provide better performance and lower cost.

However, other types of fluorescent lamps called cold cathode fluorescent lamps (CCFL) outperform both HCFLs and CFLs due to their longer lifetime, simple manufacturing processes and higher efficiency. The CCFLs are used extensively for backlighting of monitors but are not used often for general purpose lighting applications such as residential lights. As in the case of the CFL, helical shaped CCFL lamps are desirable because of the high light output but would suffer from the same disadvantages as the CFL.

The CCFL is not used widely in residential lighting, because the conventional mechanical design of a CCFL including a ballast, an inverter and other required electronic components cannot be packaged in a standard lighting base such as an Edison base.

Long lived lighting appliances, such as the common double helix spiral shaped CFLs, in use will eventually be coated with a layer of dust. Cleaning the dust off the double helix spiral is difficult because of its shape. A transparent globe can be placed around the double helix to aid in cleaning but the globe can cause issues by blocking the airflow around the double helix and the electronic components.

Therefore, lighting manufactures are eager to develop a CCFL lamp with a form that allows the CCFL lamp to be mounted on a standard lamp base such as an Edison base and that avoid the problems mentioned above.

### SUMMARY OF THE INVENTION

The objective of the present inventions is to provide a lighting device that will facilitate assembly of a lamp without being limited by different types of ruminant.

The lighting device in accordance with the present invention comprises a base, at least one ruminant and an electronic module. The base is a lamp connector and comprises a contact and an insulated cap. The at least one ruminant is mounted on the base. The electronic module drives the at least one ruminant, is mounted on the base and is connected electrically to the base.

### BRIEF DESCRIPTIONS OF THE DRAWINGS

FIG. 1 is an exploded perspective view of a first embodiment of a lighting device in accordance with the present invention with three U-shaped cold cathode fluorescent lamps (CCFLs);

FIG. 2 is a cross sectional side view of the lighting device in FIG. 1;

FIG. 3 is a cross sectional side view of a second embodiment of a lighting device in accordance with the present invention with a double helical fluorescent tube and an optional cap; and

FIG. 4 is a cross sectional side view of a third embodiment of a lighting device in accordance with the present invention with a single helical fluorescent tube and an optional globe.

FIG. 5 is a cross sectional side view of a fourth embodiment of a lighting device in accordance with the present invention that addresses cooling and dust mitigation.

### DETAILED DESCRIPTION OF THE PRESENT INVENTION

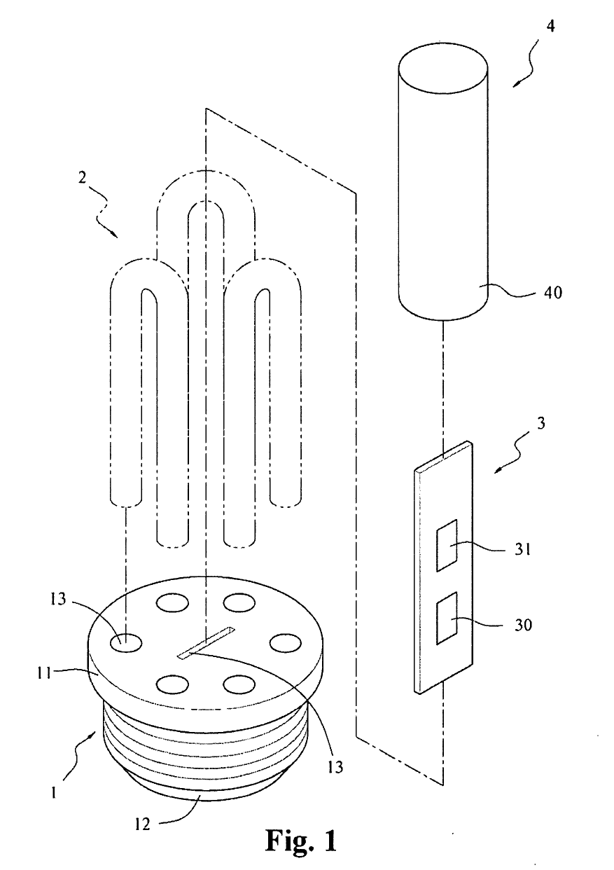

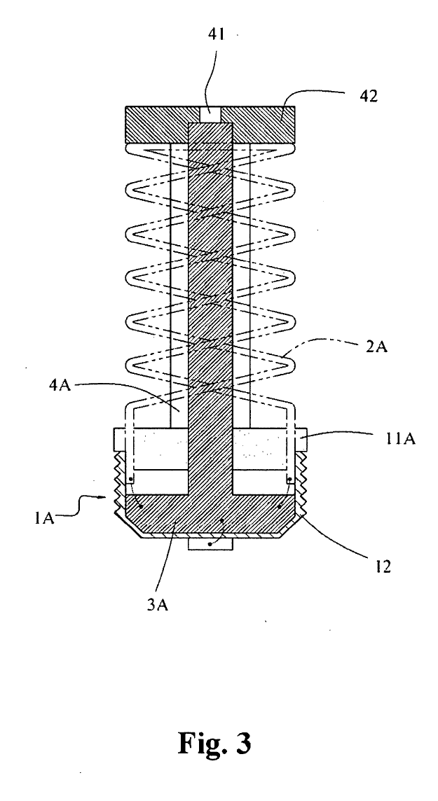

With reference to FIGS. 1, 3 and 4, a lighting device in accordance with the present invention comprises a base (1, 1A, 1B), at least one luminant (2, 102A, 2B), an electronic module (3, 3A), an optional reflector (4, 4A) and an optional globe (5).

The base (1, 1A, 1B) is a lamp connector, may be an Edison base and comprises a contact (12) and an insulated cap (11, 11A).

The contact (12) has an upper end and is mounted detachably in a lightbulb receptacle

The insulated cap (11, 11A) is mounted on the upper end of the contact (12) and comprises multiple holes (13).

At least one ruminant (2, 2A, 2B) is mounted respectively through the holes (13) in the insulated cap (11, 11A) and forms a cavity (20) on a top of the insulated pad (11, 11A), and may be selected from a group of multiple U-shaped cold cathode fluorescent lamps (CCFLs), a helical CCFL (single helix or double helix fluorescent tube), an external electrode fluorescent lamp (EEFL), a carbon nano-tube lamp (CNL) or an array of light emitting diodes (LEDs).

The electronic module (3, 3A) drives the at least one ruminant, is mounted inside the cavity, is electrically connected to the contact (12) and the at least one luminant (2, 2A, 2B) protruding respectively through the at least one hole (13) in the insulated cap (11, 11A) and comprises multiple electronic components (30) and multiple optional electronic components (31).

The electronic components (30) drive the at least one ruminant (2, 2A, 2B) and may comprise a ballast.

The optional electronic components (31) implement particular electronic capabilities such as a light adjustment sensor (photosensitive device or electronic dimming device) that controls brightness of the ruminant (2, 2A, 2B).

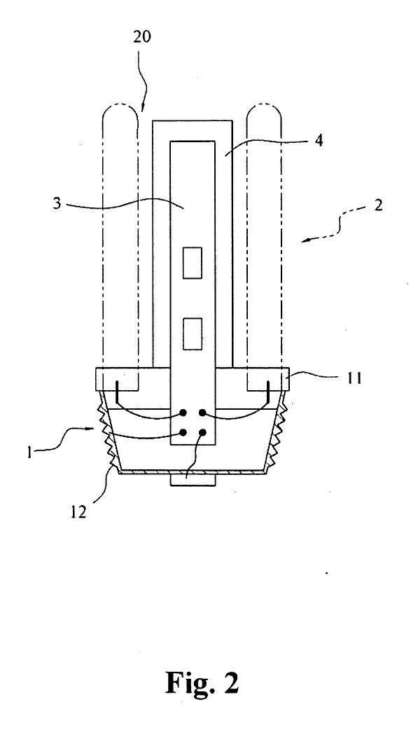

With further reference to FIG. 1-4, the reflector (4, 4A) is mounted on the base (1, 1A, 1B) and covers the electronic module (3, 3A). Thus, the reflector (4, 4A) provides an aesthetically pleasing appearance by hiding the electronic module (3) and comprises a reflecting cylinder (40), at least one optional hole (41) and an optional cylinder cap (42).

The cylinder (40) has a reflecting surface that reflects light away to provide better luminance and comprises a top end and a bottom end. The bottom end of the reflecting cylinder (40) is mounted on the insulated cap (11, 11A) of the base (1, 1A, 1B).

The cylinder cap (42) is mounted on the top end of the reflecting cylinder (40) and provides solid mechanical support for both the ruminant (2A, 2B) and the electronic module (3A). Consequently, a person can grip the lighting device without touching the ruminant (2, 2A, 2B).

The at least one hole (41) may be formed around the reflecting cylinder (40) or on the top end of the cylinder cap (42) and allows the electronic module (3A) to sense the brightness.

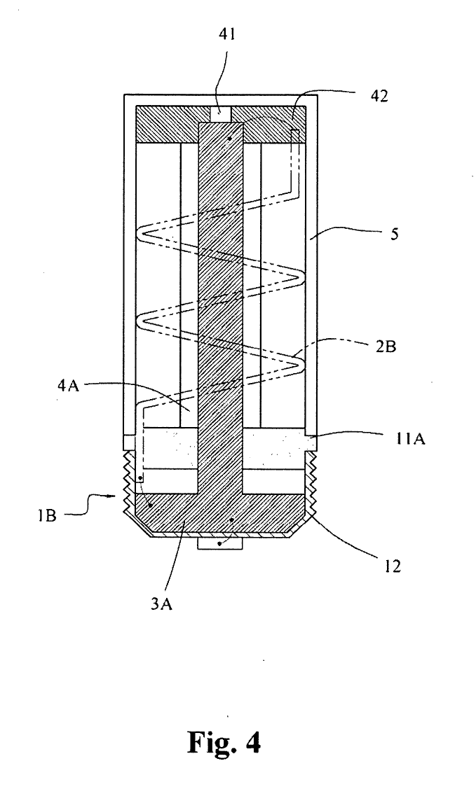

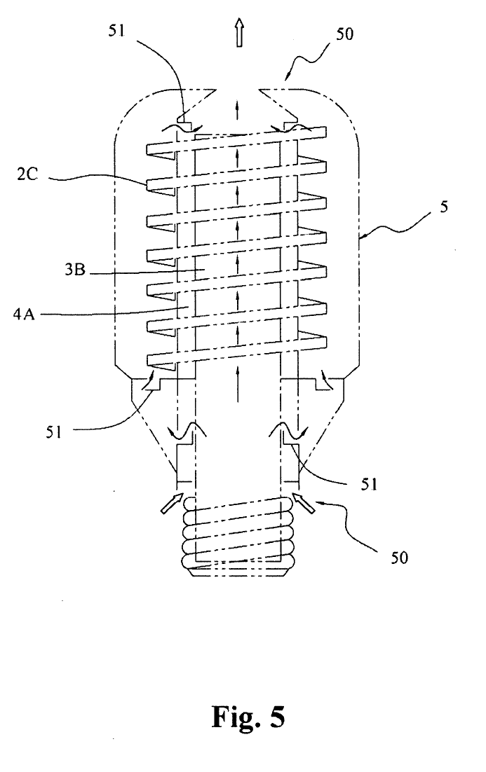

With reference to FIGS. 4 and 5, the globe (5) is mounted on and encloses the base (1) to provide extra and better protection and comprises multiple openings (50) and multiple optional baffles (51).

The openings (50) are mounted through the globe (5) and the base (1) and are made to allow airflow across the electronic module (3B), the ruminant (2C) or both. The openings (50) may be made in a top end of the globe (5), allowing warm air to exit the lighting device. Air is allowed to flow through the reflector (4A) and the electronic module (3B) before exiting from the top of the globe (5).

The baffles (51) are located in the globe (5) and may allow cooling air to flow past the ruminant (2C) of the lighting device. By providing a circuitous path for the cooling air, larger dust particles would be prevented from flowing past the ruminant (2C) and subsequently coating the ruminant (2C).

Most of the heat generated by a lighting device comes from electronic module (3B) and electrodes of the ruminant (2C). The electrodes of the ruminant (2C) are located inside the reflector (4A), along with the electronic module (3B). Therefore, one advantageous embodiment of the invention would completely block the baffles (51), preventing any air flow over the ruminant. Cooling air would still flow across the hottest areas of the invention, namely the electronic module (3B) and the electrodes of the ruminant (2C). Since no air flows across the ruminant (2C) (apart from the electrodes) there would be no dust accumulation on the ruminant (2C).

Please note that if the lighting device were oriented with the base on top and the globe opening of the bottom (opposite to FIG. 5) then the air flow would be opposite to that previously described, yet still would be quite capable of cooling the device. This is both useful, and necessary, because the specific orientation of the lighting device will be different in every different application.

People skilled in the art will understand that various changes, modifications, and alterations in form and details may be made without departing from the spirit and scope of the invention.

What is claimed is:

1. A lighting device comprising
a base being a lamp connector and comprising
a contact having an upper end and being mounted detachably in a lightbulb receptacle; and
an insulated cap being mounted on the upper end of the contact and comprising multiple holes; and
at least one ruminant being mounted respectively through the holes in the insulated cap and forming a cavity on a top of the insulated pad; and
an electronic module driving the at least one ruminant, being mounted inside the cavity, being electrically connected to the contact of the base and the at least one ruminant protruding respectively through the at least one hole in the insulated cap and comprising multiple electronic components driving the at least one ruminant.

2. The lighting device as claimed in claim 1, wherein
the electronic module further comprises
electronic components that drive the at least one ruminant; and
the electronic module further comprises multiple electronic components to implement particular electronic capabilities.

3. The lighting device as claimed in claim 1 further comprising a globe being mounted on and enclosing the base to provide extra and better protection.

4. The lighting device as claimed in claim 1, wherein the ruminant is a multiple U-shaped cold cathode fluorescent lamp.

5. The lighting device as claimed in claim 1, wherein the ruminant being a helical cold cathode fluorescent lamp.

6. The lighting device as claimed in claim 1, wherein the ruminant being an external electrode fluorescent lamp.

7. The lighting device as claimed in claim 1, wherein the luminant being a carbon nano-tube lamp.

8. The lighting device as claimed in claim 1, wherein the ruminant being an array of light emitting diodes.

9. The lighting device as claimed in claim 1, wherein the base being an Edison base.

10. The lighting device as claimed in claim 2 further comprising a reflector being mounted on the base and covering the electronic module and comprising a reflecting cylinder having a reflecting surface that reflects light away to provide a better luminance and comprises
a top end; and
a bottom end being mounted on the insulated cap of the base.

11. The lighting device as claimed in claim 10, wherein the reflector further comprising
multiple holes being formed around the reflecting cylinder and corresponding to the electronic module.

12. The lighting device as claimed in claim 10, wherein the reflector further comprises
a cylinder cap being mounted of the top end of the reflecting cylinder, providing solid mechanical support for both the at least one ruminant and the electronic module.

13. The lighting device as claimed in claim 3, wherein the globe comprises
multiple openings being mounted through the globe and the base and being made to allow airflow across the electronic module, the ruminant or both.

14. The lighting device as claimed in claim 13, wherein the globe further comprises
multiple baffles providing a circuitous route for airflow across the ruminant in order to separate out some of the dust from the airflow that might otherwise come into contact with the ruminant.

15. A heat dispersing method using a lighting device of claim 14, comprising
providing a circuitous path for cooling air into the lighting device; and
guiding the cooling air to a section with most heat.

16. A heat dispersing method as claimed in claim 15, wherein guiding the cooling air to the section with most heat further comprises
blocking most cooling air from the ruminant; and
allowing most cooling air flow through an electronic module and electrodes of the lighting device.
